(19) United States
(12) Patent Application Publication
(10) Pub. No.: US 2004/0245321 A1
(43) Pub. Date: Dec. 9, 2004

(54) Method and device for producing a closed metal profile or metal tube with wall thickness varying in the longitudinal direction

(75) Inventor: Gerhard Spitz, Schopfheim (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Dreistern GmbH & Co. KG, Schopfheim (DE)

(21) Appl. No.: 10/822,628

(22) Filed: Apr. 12, 2004

(30) Foreign Application Priority Data
Apr. 10, 2003 (DE) 103 16 336.0

(51) Int. Cl. B23K 31/00

(52) U.S. Cl. 228/173.6

(57) ABSTRACT

A method and a roll-forming system for producing a metal profile are provided, wherein the wall thickness of the metal profile varies along its longitudinal axis. For this purpose, a sheet-metal strip with a thickness that varies along its length is used. Before welding together the profile or tube, which is manufactured through shaping into a closed profile or tube, this piece is sized to a desired outer diameter and in this way any existing ripples in the strip edges are made level, so that a simple, conventional straight welding of the profile or tube is possible.

### BACKGROUND

The invention relates to a method for producing a closed metal profile or metal tube, whose wall thickness varies along its longitudinal axis. The invention also relates to a roll-forming system for performing this method. Roll-forming systems and methods for roll forming of sheet-metal strips have been used for a long time for producing closed metal profiles or metal tubes and are very common; however, up until now it was only possible to produce metal profiles or metal tubes, whose wall thickness remained constant along the longitudinal axis.

Especially for profiles and tubes made from high-quality materials, as well as for the use in products to be constructed as light and yet as stable as possible, it is often desirable to form the walls of the profile or tube somewhat thicker only where necessary for reasons of stability.

Methods for producing profiles with wall thickness varying over their cross section from a sheet-metal strip by means of roll-forming tools have become known, e.g., from WO 00/29138 and also from applicant's EP 1 210 998 A2. In these publications, initially a sheet-metal strip is produced, whose thickness varies perpendicular to its longitudinal direction. Then this specially produced sheet-metal strip is shaped in a conventional roll-forming system into a profile with varying wall thickness.

This principle, however, cannot be easily transferred to sheet-metal strips with thickness varying along their length and which could then be used to produce a metal profile or metal tube. Apart from the fact that roll forming performed on sheet-metal strips in the conventional sense is basically suitable only for processing metal sheets with constant thickness in the longitudinal direction, the roll forming of a sheet-metal strip having a varying thickness along its length leads to a barely weldable intermediate product. This is because the bend radii, which are produced by roll forming of a sheet-metal strip, depend on the thickness of the strip. The position of the neutral fiber for bending the sheet metal is located approximately in the center between the upper and lower sides of the sheet-metal strip. Consequently, the neutral fiber is at a greater distance from the surfaces of the roll-forming tools for thick sheet-metal strips than for thin strips. In addition, the edge regions of the bend radii are compressed when a sheet-metal strip is passed through a roll-forming tool pair with radii designed for a thinner sheet-metal strip. As a result, a profile or tube is created, wherein the narrow sides of the sheet-metal strip contact each other only in the sections with a greater sheet-metal thickness. In the sections of the profile or the tube with a smaller sheet-metal thickness, a greater or smaller gap remains between the narrow sides of the sheet-metal strip, which makes conventional straight welding for closing the profile or tube much more difficult or even impossible.

Therefore, the invention is based on the problem of manufacturing not only profiles with constant wall thickness or with a wall thickness that varies only in its cross section, but also profiles and tubes with a wall thickness that varies in the longitudinal direction, through roll forming.

### SUMMARY

This problem is solved by a method according to the invention, as well as by a roll-forming system having several novel features in accordance with the invention.

The core of the method according to the invention includes the following processing steps: initially, a sheet-metal strip with a thickness varying along its length is used, which was viewed as impossible or at least very disadvantageous and undesired in the prior state of the art, and fed to a roll-forming system with roll-forming tools, where it is shaped into a profile or tube. Now, before the profile or tube manufactured through shaping is further processed lengthwise into a closed profile or tube in a conventional manner in a welding station, the shaped profile or tube is sized to predetermined outer dimensions in an entirely novel intermediate step by means of at least one sizing roller pair. This sizing can bring the profile or the tube to its final desired outer dimensions, but this is not necessary.

Thus, relative to the prior state of the art, the known sizing of the profile or tube to predetermined outer dimensions, which is performed after the welding station in the state of the art, is moved before the welding station. This enables the tubes and profiles manufactured in a roll-forming system to be welded into a closed profile or tube in a conventional welding station. This is because, as discussed in the introduction, the material of the sheet-metal strip stretches differently during shaping according to the thickness of the sheet-metal strip in the circumferential direction, so that a gap remains open for the sections with smaller wall thickness, where the welding seam should run.

The modified roll-forming system according to the invention for performing the method just described is distinguished in that at least one sizing roller pair is arranged between the roll-forming tools and the welding station in order to perform the novel “intermediate sizing” for enabling conventional straight welding.

The scope of the invention does not generally exclude the condition where the wall thickness of the used sheet-metal strip varies not only in the longitudinal direction, but also along its cross section, so that the profiles or tubes manufactured according to the invention can be optimized exactly for the appropriate application.

The sizing rollers are preferably arranged with an atypical orientation. Normally, a tube or a closed profile passes through the sizing rollers for final sizing after the welding station so that the welding seam extends in the center through one of the two sizing rollers. According to the present invention, this should not be the case; especially preferred is an arrangement of sizing rollers, for which the welding seam (according to the invention still not even present) comes to lie in the edge region between the two sizing rollers. In other words, the profile or tube should be guided through the sizing rollers, so that the connection plane between the longitudinal center axis of the profile or tube and the center line between the narrow sides of the sheet-metal strip is different from the rotational plane of the sizing rollers. Preferably the connection plane is approximately at a right angle to this rotational plane. This has the following advantages:

As the diameter of the roller becomes smaller, in the region of the groove base, the contact surface between the sizing roller and the tube or profile decreases, which increases the surface pressure. Now, if a tube or profile, which has not yet been welded, is guided in a conventional arrangement through a sizing roller pair, the surface pressure at the not yet welded strip edges is especially high, which leads to elongation of the strip. However, this produces the risk of a kink in the tube or profile, especially in the sections with thinner wall thickness and at the transition regions between a smaller and a greater wall thickness. Ripples can likewise be formed in the welding region, which leads to a poor welding result, and the tube ends can project like a trumpet.

With the preferred, novel arrangement of sizing rollers, these effects are prevented, because especially high surface pressures no longer occur at the strip edges. Similarly, the gaps present in the thin sections of the tube or profile at the strip edges are closed by the sizing, so that subsequent straight welding is no longer a problem.

Preferably, a sheet-metal strip is used, for which the sections of different strip thickness are set relative to each other so that the strip centers of the different sections lie against each other. The neutral fiber for shaping then always lies in the center in the material, which advantageously minimizes the transverse strains between the sections of different sheet-metal thickness. The outer dimensions are made level by the intermediate sizing, so that the thickness changes are finally located in the inside of the tube or profile.

The shaping of the sheet-metal strip can be performed by means of roll-forming tools, which form a roller gap interacting in pairs, wherein the inner width of the roller gap is varied according to the strip thickness of the section of the sheet-metal strip located at that moment in the gap. This can be achieved by a configuration that can change the position of one of two roller forming tools interacting in pairs, wherein the roller is preferably moved perpendicular to the longitudinal direction of the sheet-metal strip. Adjusting the roller gap to varying sheet-metal thickness values prevents the roller gap form being too large for thin sections of the sheet-metal strip, which would produce an undefined deformation of the strip, and also prevents the roller gap from being too narrow for thick sections of the strip, which would lead on one hand to a poor production result and on the other hand would endanger the mounting of the roll-forming tool through pressure.

The roll-forming tools, which can change in position for varying the roller gap, are provided in an especially preferred way with a motor-driven, hydraulic or pneumatic adjustment mechanism or else they are spring mounted and able to move in position, so that they automatically adjust to the thickness of the section of the sheet-metal strip located at the moment in the gap.

The movements of the position-changing roll-forming tools can be actively controlled corresponding to the profile of the thickness of the sheet-metal strip, e.g., by means of a computer, which stores the thickness profile of the sheet-metal strip, while the progress of the production work is preferably reported over a path-length measurement device to the computer, or, e.g., corresponding to the values measured by a sensor unit for strip thickness measurement. The movements of the position-changing roll-forming tools, however, can also be achieved passively through spring mounting or, e.g., by means of an excess pressure limit in a hydraulic adjustment mechanism. The position-changing roll-forming tool then flexes against the spring force or due to the excess pressure limit, when the sheet-metal strip becomes thicker in the roller gap, while the roller gap then automatically becomes narrower again, when the intermediate strip thickness decreases. In this way, the roll-forming system can be adapted automatically to each sheet-metal strip topography, even when the active control of the roller gap mentioned above can also be provided, without it being necessary to store all of the data in advance in the controller or to install complicated sensor technology.

### BRIEF DESCRIPTION OF THE DRAWINGS

The invention is explained in more detail with reference to the included drawings of an exemplary embodiment. In the drawings:

FIG. 1 is a schematic representation of a stand with roll-forming tools in configuration according to the invention together with schematic representation of a hydraulic adjustment mechanism;

FIG. 2 is a schematic representation of a cylindrical tube manufactured through roll forming with three sections of different wall thickness; and

FIG. 3 is a schematic representation of a sizing roller pair with a tube passing through the rollers.

### DETAILED DESCRIPTION OF THE PREFERRED EMBODIMENTS

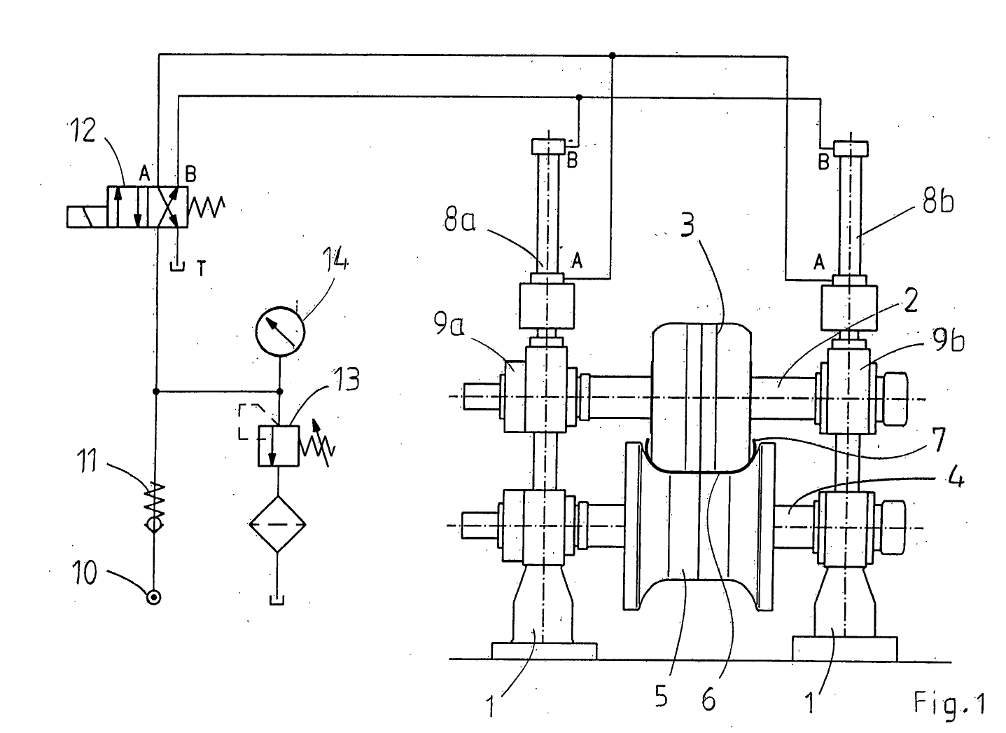

FIG. 1 shows the schematic view of a stand 1, in which an upper roll-forming tool 3 is supported on an upper drive shaft 2 and a lower roll-forming tool 5 is supported on a lower drive shaft 4. In the roller gap 6 formed by the interacting roll-forming tools 3, 5, an already partially profiled sheet-metal strip 7 can be seen. A roll-forming system according to the invention usually includes a plurality of such stands arranged one behind the other, wherein the roll-forming tools are configured differently, adapted to the appropriate shaping step.

The special feature of the illustrated stand 1 is that the upper drive shaft 2 does not sit rigidly on the stand 1, but instead is supported so that its height can change. For this purpose, there are two hydraulic cylinder units 8a and 8b, which are supported on one side on the stand 1 and on the other side on the bearings 9a, 9b of the upper drive shaft 2. Here, these cylinder units comprise a double-acting hydraulic cylinder, which can produce a defined change in height of the upper drive shaft 2 and thus a defined setting of the roller gap 6.

The hydraulic line layout for the hydraulic cylinders 8a, 8b is shown schematically in FIG. 1. The hydraulic cylinders 8 are provided with hydraulic oil by a pump 10 through a non-return valve 11 and a two-way valve 12. The two-way valve 12 enables reversal of the hydraulic cylinder 8. If the line A is pressurized, the upper drive shaft 2 moves to an upper stop and thus to a maximum opening of the roller gap 6. If the line B is pressurized by activating the two-way valve 12, as shown in FIG. 1, the drive shaft 2 drops to a lower stop, so that the roller gap 6 closes to its smallest extent. The two-way valve 12 thus enables, in interaction with the double-acting hydraulic cylinders 8, the active control of the roller gap 6 described above, which is then completely sufficient, especially when the work involves only two different sheet-metal strip thickness values.

In addition, an over-pressure valve 13 for two-way valve 12 can be seen in the hydraulic circuit diagram of FIG. 1. This over-pressure valve is activated by a pressure measurement device 14 as soon as the hydraulic pressure established in the hydraulic system exceeds a threshold. These simple means allow the roller pressure between the upper roll-forming tool 3 and the lower roll-forming tool 5 to be regulated automatically to a constant value, independent of the size of the roller gap 6 and thus independent of the thickness of the sheet metal 7, in interaction with a suitably powerful pump 10. Then, as soon as a thicker section of the sheet-metal strip 7 enters into the roller gap 6, the roller pressure increases and thus also the pressure in the line B. Now, if the over-pressure valve 13 is opened, the upper roll-forming tool 3 flexes, in that the upper drive shaft 2 moves upwards until the hydraulic pressure in the line B drops again below the threshold for activating the over-pressure valve 13. The pump 10 then provides that the hydraulic pressure does not fall farther and thus the roller pressure between the roll-forming tools 3 and 5 are kept steady. In the reverse direction, if the sheet-metal strip 7 in the roller gap 6 becomes thinner, the hydraulic pressure established by the pump 10 in the line B provides that the upper drive shaft 2 is moved immediately downwards, so that the roller gap 6 closes correspondingly between the upper roll-forming tool 3 and the lower roll-forming tool 5.

The hydraulic adjustment mechanism shown in FIG. 1 thus combines an active control possibility of the roller gap opening by means of the two-way valve 12 with an automatic regulation of the roller pressure by means of the over-pressure valve 13. For abrupt changes in thickness of the sheet-metal strip 7, it can be advantageous to perform the change of the roller gap 6 through an active reversal of the two-way valve 12, if necessary, also for automatic roller pressure regulation. In the reverse direction, the over-pressure valve 13 in the active control mode takes over a safety function against impermissible overpressure in the hydraulic system independent of the ability to regulate the roller pressure.

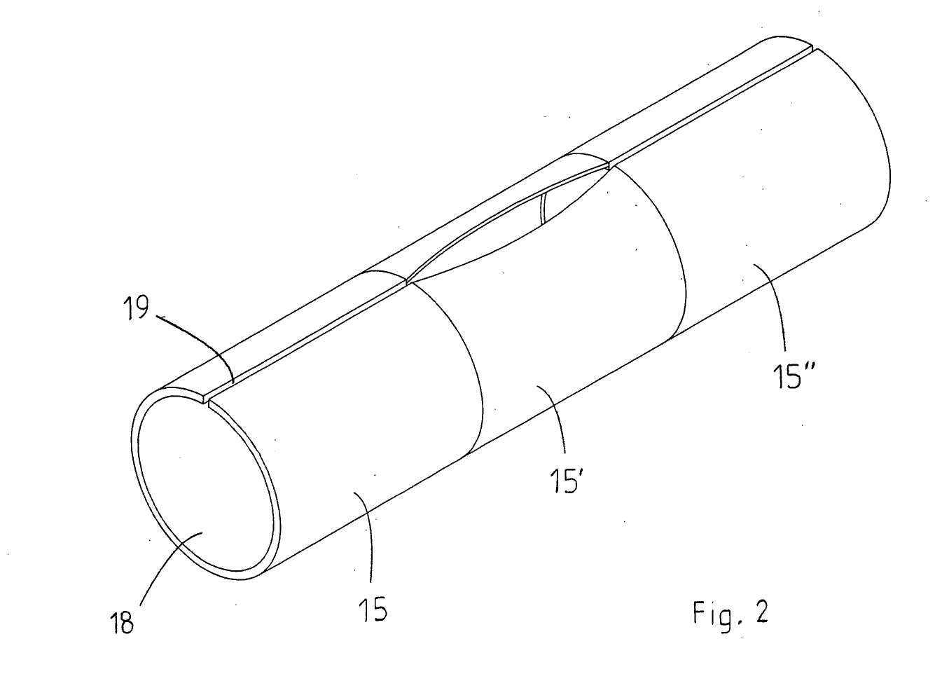

FIG. 2 shows schematically a cylindrical tube 18 manufactured by means of roll forming from a sheet-metal strip with three sections of different thickness. A first section 15 has a greater wall thickness, so that the strip edges lie edge to edge. A second section 15′, which is welded with the first section 15 in the center, has a smaller wall thickness, so that here the strip edges do not lie edge to edge, but instead a gap remains, which makes simple straight welding impossible for closing the tube 18. At the other end of the second section 15′, a third section 15″ is welded, which has in turn the same wall thickness as the first section 15.

FIG. 2 thus shows the situation before the sizing according to the invention and straight welding for completing the tube 18.

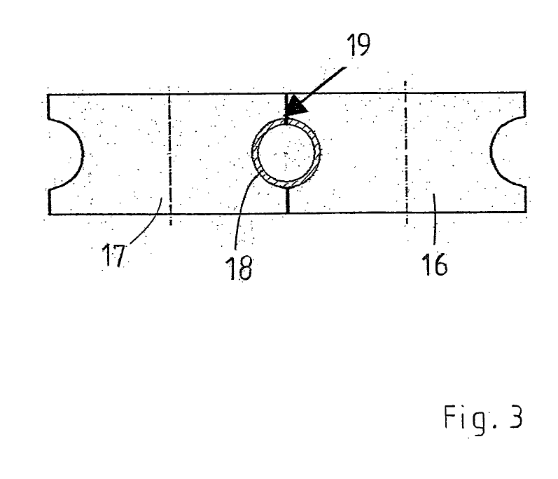

Now, in FIG. 3a sizing roller pair 16, 17 is shown schematically, in which the tube 18 from FIG. 2 is intermediate-sized before the welding. The seam 19, thus the later welding seam, lies in the edge region between the two sizing rollers 16 and 17. The connection plane between the seam 19 and the longitudinal center axis of the tube 18 thus extends perpendicular to the rotational plane of the two sizing rollers 16 and 17. As already described, the largest surface pressures on the tube 18 exist in the rotational plane of the two sizing rollers 16, 17, thus, here, advantageously not in the region of the seam 19. In contrast, because the seam 19 is located in the contact region of the two sizing rollers 16, 17, at this point a lengthening of the tube material is barely taken into account, so that the gap shown in FIG. 2 does close, but there is no risk of ripples or kinks in the material at the seam 19. The subsequent straight welding for completing the tube 18 can thus be performed using conventional methods. If necessary, an end sizing can obviously also be performed after the welding station.

### List of Reference Symbols

1 Stand

2 Drive shaft (upper)

3 Roll-forming tool (upper)

4 Drive shaft (lower)

5 Roll-forming tool (lower)

6 Roller gap

7 Sheet-metal strip

8 Hydraulic cylinder

9 Bearing (of 2)

10 Pump

11 Non-return valve

12 Two-way valve

13 Over-pressure valve

14 Pressure measurement device

15 15′, 15″ Section (of 18)

16 Sizing roller

17 Sizing roller

18 Tube

19 Seam

1. Method for producing a closed metal profile or metal tube, having a wall thickness that varies along a longitudinal axis thereof, comprising:
shaping a sheet-metal strip with a strip thickness that varies along a length thereof into a profile or tube using roll-forming tools,
sizing the profile or tube in at least one sizing roller pair to predetermined outer dimensions, and
welding edges of the sheet-metal strip that are brought together through the shaping and sizing to one another in order to complete the closed profile or tube.

2. Method according to claim 1, wherein the profile or tube is guided through the at least one sizing roller pair so that a connection plane between a longitudinal center axis of the profile or tube and a center line between the edges of the sheet-metal strip is different from a rotational plane of the sizing roller pair.

3. Method according to claim 2, wherein the connection plane between the longitudinal center axis of the profile or tube and the center line between the edges of the sheet-metal strip is set approximately at a right angle to the rotational plane of the sizing rollers.

4. Method according to claim 1, wherein the sheet-metal strip includes sections of different strip thickness that are set relative to each other so that centers of the strip from the different sections lie against each other.

5. Method according to claim 1, wherien the shaping of the sheet-metal strip into a profile or tube is performed by the roll-forming tools, which form a roller gap interacting in pairs, having an inner width that is varied corresponding to the strip thickness of a section of the sheet-metal strip located at that moment in the gap.

6. Method according to claim 5, wherein the roller gap is adjusted automatically to the thickness of the section of the sheet-metal strip located at that moment in the gap based on the use of the roll-forming tools, two of which interact, and at least one of the two roll-forming tools is configured to change position using at least one of a motor, a spring mounting, a hydraulic drive, or a pneumatic drive.

7. Method according to claim 6, wherein the position-changing roll-forming tool is pre-tensioned and/or set pneumatically or hydraulically.

8. Method according to claim 6, wherein movements of the position-changing roll-forming tool are actively controlled according to a profile of the thickness of the sheet-metal strip.

9. Method according to claim 8, wherein a computer controls the movements by storing the thickness profile of the sheet-metal strip, wherein progress of the production work is reported to the computer over a path-length measurement device.

10. Method according to claim 8, wherein the movement of the position-changing roll-forming tool is controlled according to values measured by one or more sensor units for strip thickness measurement.

11. A roll-forming system for performing the method according to claim 1, the system comprising a plurality of roll-forming tools (3, 5) for shaping a sheet-metal strip (7) into a metal profile or metal tube (18), with a welding station for straight welding of the sheet-metal strip (7) into a closed metal profile or metal tube (18) after it is shaped, and with at least one pair of sizing rollers (16, 17) for sizing the profile or tube (18) to predetermined outer dimensions, wherein the sizing rollers (16, 17) are arranged between the roll-forming tools (3, 5) and the welding station.

12. Roll-forming system according to claim 11, wherein the sizing rollers (16, 17) are arranged so that a connection plane between a longitudinal center axis of the profile or tube (18) and a center line between edges (19) of the sheet-metal strip (7) is different from a rotational plane of the sizing rollers (16, 17).

13. Roll-forming system according to claim 12, wherein the connection plane between the longitudinal center axis of the profile or tube (18) and the center line between the edges (19) of the sheet-metal strip (7) is generally perpendicular to the rotational plane of the sizing rollers (16).

14. Roll-forming system according to claim 11, wherein at least one part of the roll-forming tools (5, 6) are arranged interacting in pairs so that a roller gap (6) is formed therebetween for simultaneous action on the sheet-metal strip guided through the roll-forming tools (3, 5), at least one of two roll-forming tools (3) interacting in pairs is configured to change position for adjusting the roller gap (6) to a variable thickness of the sheet-metal strip (7) during the shaping process relative to the associated roll-forming tool (5).

15. Roll-forming system according to claim 14, wherein the position-changing roll-forming tool (3) is configured to change position by spring mounting.

16. Roll-forming system according to claim 14, wherein the position-changing roll-forming tool (3) is provided with a motor driven, hydraulic, or pneumatic adjustment mechanism (8).

17. Roll-forming system according to claim 16, wherein the adjustment mechanism (8) is provided with an over-pressure limit (13) for roller pressure.

18. Roll-forming system according to claim 16, wherein the adjustment mechanism (8) is provided with a controller for adjusting the roller gap (6) as a function of the varying thickness of the sheet-metal strip (7).

19. Roll-forming system according to claim 18, wherein the controller includes a memory, which stores the thickness profile of the sheet-metal strip (7).

20. Roll-forming system according to claim 18, wherein the controller of the adjustment mechanism (8) is connected to a sensor unit for strip thickness measurement.
